(19) United States
(12) Patent Application Publication
(10) Pub. No.: US 2014/0303285 A1
(43) Pub. Date: Oct. 9, 2014

(54) NOVEL BIODEGRADABLE MASTER BATCH AND PREPARATION METHOD THEREOF

(71) Applicant: Lianlong Hou, Jiangsu (CN)

(72) Inventor: Lianlong Hou, Jiangsu (CN)

(73) Assignee: SHANGHAI ZAIHE INDUSTRIAL INVESTMENT CO., LTD., Shanghai (CN)

(21) Appl. No.: 14/235,243

(22) PCT Filed: Jul. 27, 2012
(86) PCT No.: PCT/CN2012/079263

§ 371 Date: May 8, 2014

(30) Foreign Application Priority Data
Jul. 29, 2011 (CN) 201110216621.X

(51) Int. Cl. C08L 67/04; C08L 63/00

(52) U.S. Cl. CPC C08L 67/04; C08L 63/00
USPC 523/451

(57) ABSTRACT

The present invention provides a biodegradable master batch and a preparation method thereof. The biodegradable master batch is prepared by in-situ polymerization of the components in the following formula in weight parts: 10-80 parts of biodegradable monomer or prepolymer, 0.01-5 parts of catalyst, 0.05-5 parts of reaction activator, 0.1-5 parts of thermal stabilizer, 0-80 parts of flame retardant, 0-80 parts of filler, 0-80 parts of antistatic agent, 0-80 parts of pigment, 0-80 parts of foaming agent, and 0-5 parts of surface coupling agent. Provided in the present invention are the biodegradable polymer master batch having good dispersion effect and excellent interface bonding property, and the preparation method thereof.

### TECHNICAL FIELD

The present invention relates to a master batch and preparation thereof, and in particular to a novel biodegradable master batch and a preparation method and process thereof.

### BACKGROUND

There are a wide variety of functional master batches, such as filler master batches, flame retardant master batches, antistatic master batches, color master batches and the like. Initially, plastic master batch is only a premix of fillers, carrier resins and a small amount of necessary auxiliaries. With the development of plastic industry, it is hoped to find a filler that is capable of keeping or further improving the performances of plastic products even in case of higher addition amount, thus on one hand, activation and modification are carried out on fillers using coupling agents or surfactants, and on the other hand, modifying agents and a variety of auxiliaries are applied to imparting the plastic products with better properties. Then, plastic master batch is not limited to filler master batches that are used for the purpose of cost reduction, moreover, there exists a variety of functional master batches for special use. The filler master batches and a variety of functional master batches can be added to a plastic matrix conveniently to impart flame retardance, antistatic property and other performances to plastic products, as a result of this, these plastic products meet the demands in different application fields.

Most of the additives in plastic master batches are inorganic, and they are molding compounds, so there is no change of their performances during processing of a polymer material. Hence, those various properties that inherently exist in additives will be brought into the polymer to affect or even alter its property. The size and dispersion uniformity of additive particles place a tremendous impact upon the performances of the finished plastic. In general, finer particles lead to more difficult processing and dispersion, however, this situation is favorable for comprehensive mechanical performances of plastics. The surfaces of the additives, especially inorganic additives, are hydrophilic, whereas resin matrix is lipophilic. Typically, a simple or complex method must be adopted after addition of the additives to carry out transition treatments from hydrophilicity to lipophilicity on the particle surfaces, different kinds of surfactants could be used in these treatments, ranging from universal surfactants to specific surfactants synthesized based on different inorganic surfaces and polymer matrixes, these surface modification treatments that enhance the dispersibility and double-phase (multi-phase) interface bonding force of particles cause increase of the preparation cost of master batches, and for some products that are hardly modified, their effects are unsatisfactory.

In addition, due to the increasingly prominent problems of environmental pollution caused by waste plastics and depletion of nonrenewable resources like petroleum, generation of biodegradable plastic is becoming one of the effective ways in plastic industry to relieve the contradiction in petroleum resource aspect and to control environmental pollution, and has been recognized and accepted by publics. Commercial biodegradable plastic products are usually blended with these materials or other materials to meet the demands in use. Currently, what is needed for all these biodegradable plastics is to continue lowering the cost and spare no effort to improve the product performances, processability and usability, in order to boost their competitiveness relative to ordinary plastics and therefore gain more market shares. Development of the biodegradable master batch, which is indispensable to biodegradable plastic, will definitely be an important and promising tendency.

To sum up, preparation of the master batches is typically featured by addressing the problem of poor interface bonding force between plastic matrix and additives only by surfactants, and use of such master batches could tend to arouse degradation in mechanical performances undesired dispersion and poor modification effect in the finished plastic products. Thus, this field lacks a biodegradable master batch having good dispersion effect and excellent interface bonding property.

Thus, there is an urgent need in this field to develop a biodegradable master batch having good dispersion effect and excellent interface bonding property, and a preparation method thereof.

### SUMMARY OF THE INVENTION

A first object of the present invention is to obtain a biodegradable master batch having good dispersion effect and excellent interface bonding property.

A second object of the present invention is to obtain a preparation method of the biodegradable master batch having good dispersion effect and excellent interface bonding property.

In the first aspect of the present invention, provided is a biodegradable master batch, which is prepared by in-situ polymerization of the components in the following formula in weight parts:

10-80 parts of biodegradable monomer or prepolymer;

0.01-5 parts of catalyst;

0.05-5 parts of reaction activator;

0.1-5 parts of thermal stabilizer;

0-80 parts of flame retardant;

0-80 parts of filler;

0-80 parts of antistatic agent;

0-80 parts of pigment;

0-80 parts of foaming agent; and

0-5 parts of surface coupling agent.

Specifically, the biodegradable monomer/prepolymer may be one of the monomers, or some of the monomers in combination. The biodegradable monomer/prepolymer may also be a prepolymer formed by these monomers, etc.

Specifically, the catalyst is selected from those that are required in polymerization of these monomers.

In one embodiment of the present invention, the biodegradable monomer is hydroxy acid, diacid, diol, triol, tetrol, ester or combinations thereof used in preparation of biodegradable polymer; the prepolymer is a prepolymer derived from the hydroxy acid, diacid, diol, triol, tetrol, ester or combinations thereof and having a degree of polymerization of 50-5000.

In one embodiment of the present invention, the biodegradable monomer is lactic acid, succinic acid, adipic acid, terephthalic acid, butanediol, glycerol, pentaerythritol, lactide, glycolide, caprolactone or combinations thereof;

The prepolymer is a prepolymer derived from the lactic acid, succinic acid, adipic acid, terephthalic acid, butanediol, glycerol, pentaerythritol, lactide, glycolide, caprolactone or combinations thereof and having a degree of polymerization of 50-5000.

In one embodiment of the present invention, the catalyst includes Group I-V metals in the periodic table of elements, metal salt, hydroxide, chloride, oxide or combinations thereof;

Preferably, the catalyst is the metal below: zinc, tin, aluminum, magnesium, antimony, titanium, zirconium or combinations thereof; or the salt, hydroxide, chloride, oxide of the metal;

More preferably, the catalyst is: zinc oxide, zinc lactate, zinc stearate, stannous chloride, stannous octoate, tetrabutyl tin, aluminum oxide, titanium butoxide, butyl titanate, isopropyl titanate, titanium tetraisopropoxide, antimony oxide, ferric oxide, ferric acetylacetonate or combinations thereof.

In one embodiment of the present invention, the reaction activator is epoxy group activator, anhydride group activator, isocyanate group activator, oxazoline group activator or unsaturated double bond-containing reaction activator capable of reacting with carboxyl and hydroxyl.

In one embodiment of the present invention, the epoxy group activator includes: epoxy group-containing acrylate epoxy group activator, glycidyl methacrylate epoxy group activator and epoxidized soybean oil epoxy group activator;

Preferably, the epoxy group activator is an epoxy group activator of the oligomer or prepolymer containing at least 3 epoxy groups/chain segments and having a molecular weight lower than 5000.

A specific activator suitable for the system of the present invention is Joncryl™ series products from BASF Corporation, U.S.A. Other reaction activators may be carbodiimides, anhydrides or isocyanate substances, including: dicyclohexyl carbodiimide, diisopropyl carbodiimide, bis(2,6-diisopropylphenyl)carbodiimide, 1-ethyl-(3-dimethylaminopropyl)-carbodiimide hydrochloride, Stabaxol-P, Stabaxol-P200, Stabaxol-100 and Stabaxol-I from Rhein Chemie, Germany, maleic anhydride, glycidyl methacrylate, 1,6-cyclohexyl diisocyanate, 4,4′-methylene bis(cyclohexyl isocyanate), lysine methyl ester diisocyanate, butane diisocyanate, etc.

In one embodiment of the present invention, the thermal stabilizer is phosphate complex antioxidant, hindered phenol complex antioxidant and complex antioxidant of the both, including: triaryl phosphite, trialkyl phosphite, trialkyl aryl phosphate ester, alkyl aryl phosphate ester, trithio alkyl ester, bis-phosphite and polymeric phosphite, pentaerythritol ester, and mixtures thereof.

The primary commercial products of the thermal stabilizer are: antioxidant 1010, antioxidant 168, TNPP, Irgafos168, Ultranox626, Cyanox2777, Irganox B, Irganox LC, IrganoxLM, IrganoxHP, IrganoxXP, Ultranox815A, Ultranox 817A, Ultranox 875A, Naugard900, CyanoxXS4, etc.

In one embodiment of the present invention, the flame retardant is additive flame retardant, including zinc borate, zinc fluoroborate, aluminum hydroxide, magnesium hydroxide, magnesium stearate, antimony trioxide, red phosphorus, phosphate ester, ammonium polyphosphate, ammonium polyphosphate, phosphor-nitrogen flame retardant, silicon compound, copper nitrate, silver nitrate, expandable graphite, montmorillonite, layered double hydroxide, melamine, dicyandiamide, guanidine salt and derivatives thereof, tin molybdenum compound, silicon dioxide; and/or

the filler is silicate filler, silica filler, oxide filer and metal powder filler, including: calcium carbonate, calcium sulfate, montmorillonite, talcum powder, starch, chitosan, chitin, glass bead, asbestos, mica, silica, wood powder, shell powder, attapulgite, clay, carbon black, pottery clay, cellulose, or metal powder; and/or

the antistatic agent is cationic quaternary ammonium salt, amine salt, alkyl imidazoline, anionic phosphate, sulfonate, nonionic polyol, polyol ester, fatty acid ester, ethylene oxide adduct of alkyl amine, amphoteric quaternary ammonium salt, alanine salt, carbon black and metal powder; and/or

the pigment is titanium dioxide, carbon black, lithopone, chrome yellow, iron blue, iron oxide yellow, silver powder, brass powder, pigment scarlet, aza yellow, phthalocyanine blue, quinacridone, cinnabar, red clay, realgar, malachite green, calcium carbonate, wollastonite, barite powder, talcum powder, mica powder, or kaolin; and/or

The foaming agent is mainly an additive-type chemical and physical foaming agent: mainly including: azo compounds, N-nitroso compounds, sulfonyl hydrazide compounds, carbamido compounds, carbonates, nitrites, and physical foaming agents, etc.

The surface coupling agent is silane coupling agent, titanate coupling agent, aluminate coupling agent, bimetal coupling agent, phosphate coupling agent, borate coupling agent, chromium complex, zirconium coupling agent, rare earth coupling agent, and mixed coupling agents thereof.

The foaming agent may be specifically selected from: chemical foaming agents, including: amine azodicarboxylate, diisopropyl azodicarboxylate, azodiisobutyronitrile, ammonium azodicarbonate, barium azodicarboxylate, N, N′-dinitroso pentamethylene tetramine, N, N′-dinitroso terephthalamide, sodium nitrite-ammonium chloride mixture, urea, p-toluene sulfonyl hydrazide, phenyl sulfonyl hydrazide, p-diphenyl sulfonyl hydrazide acid, sodium bicarbonate, ammonium bicarbonate, polycarbonate/carbonate mixtures.

The common physical foaming agents are alkane and fluorocarbon compounds with a low boiling point, including n-pentane, n-hexane, n-heptane, petroleum ether, trichlorofluoromethane, dichlorodifluoromethane, dichlorotetrafluoroethane, etc.

The surface coupling agent may be selected from the group consisting of: γ-neno propyl trimethoxyzasilane, vinyl trichlorosilane, vinyl triethoxysilane, vinyl trimethoxysilane, vinyl tris(β-methoxyethoxy)silane, γ-(methacryloyloxy)propyl trimethoxysilane, β-(3,4-epoxy cyclohexyl)ethyl trimethoxysilane, γ-(2,3-epoxy propoxy)propyl trimethoxysilane, titanate coupling agent: isopropyl tri(isostearoyl)titanate, isopropyl tri(dioctyl pyrophosphate)tita nate, bis(dioctyl pyrophosphoryl)oxygen-containing titanium acetate, tetraisopropyl bis(dilauryl phosphite)titanate, isopropyl tri(dioctyl pyrophosphoryl)titanate, bis(dioctyl pyrophosphoryl)ethylene titanate, pyrophosphoric acid monoalkoxy titanate, plant acid monoalkoxy titanate, phosphoric acid monoalkoxy titanate, isopropyl di(methacryloyl)isostearoyl titanate, isopropyl tri(dioctyl phosphoryl)titanate, isopropyl tri(dodecylbenzene sulfonyl)titanate, isopropyl tri(n-ethylamino-ethylamino)titanate, etc.

In the second aspect of the present invention, provided is a preparation method of the biodegradable master batch of the present invention, which includes the steps:

(a) Providing the components of the present invention;

(b) Carrying out in-situ polymerization of the components to obtain the master batch.

In one embodiment of the present invention, in the step (b), in-situ polymerization and preparation of the master batch are carried out synchronously in an extrusion device, or

In the step (b), the components are prepolymerized at first and then extruded to obtain the master batch.

Specifically, prepolymerization is carried out in a reaction kettle.

### DETAILED DESCRIPTION OF THE EMBODIMENTS

Upon extensive and deep researches of the inventor, a novel biodegradable master batch is prepared based upon improvement of the preparation process in such a manner that: additives are firstly fully mixed with the biodegradable monomer or prepolymer, and then polymerization of the monomer or prepolymer in this mixture is initiated using an in-situ polymerization process. The master batch having good dispersibility and interface property is acquired. And the present invention is implemented on this basis.

The technical concept of the present invention is as follows:

In the present invention, additives are well dispersed in these monomers or prepolymers on the basis of good mobility and reaction activity of the monomers or prepolymers. The monomers and additives are strong in interface interaction and uniform in dispersion, furthermore, a master batch with higher addition amount is prepared. Further, a preparation method of the novel biodegradable master batch is set forth by full utilization of the features of biodegradable monomer polymerization; this method, which is different from traditional physical modification methods for preparation of the master batch, is featured by starting with the biodegradable monomer or prepolymer to prepare a biodegradable master batch having strong interface interaction and uniform dispersion through polymerization, thus a better master batch is provided for further preparation of a biodegradable composite material, besides, the master batch has a higher addition amount.

In the present invention, those terms “contain” or “include” represent that various ingredients could be applied to the mixture or composition of the present invention together. Thus, the terms “consist mainly of . . . ” and “consist of . . . ” are encompassed in those terms “contain” or “include”.

The “hydroxy acid” used herein for preparation of biodegradable polymer includes, but not limited to: lactic acid.

The “diacid” used herein for preparation of biodegradable polymer includes, but not limited to: succinic acid, adipic acid, terephthalic acid.

The “diol” used herein for preparation of biodegradable polymer includes, but not limited to: butanediol, hexanediol.

The “triol” used herein for preparation of biodegradable polymer includes, but not limited to: glycerol.

The “tetrol” used herein for preparation of biodegradable polymer includes, but not limited to: pentaerythritol.

The “ester” used herein for preparation of biodegradable polymer includes, but not limited to: lactide, glycolide, caprolactone.

Detailed description is made below to the various aspects of the present invention.

Unless specifically stated, the various raw materials in the present invention could all be commercially available, or prepared according to conventional methods in this art. Unless otherwise defined or stated, all professional and scientific terms used herein are identical to the meanings with which those skilled in this art are familiar. In addition, any methods or materials similar or equivalent to the contents documented could all be applied to the method of the present invention.

### Components

### Summarization

The formula of the prepared biodegradable master batch in the present invention is as follows:

| | |
|---|---|
| Biodegradable monomer/prepolymer | 10~80 |
| Catalyst | 0.01~5 |
| Reaction activator | 0.05~5 |
| Thermal stabilizer | 0.1~5 |
| Flame retardant | 0~80 |
| Filler | 0~80 |
| Antistatic agent | 0~80 |
| Pigment | 0~80 |
| Foaming agent | 0~80 |
| Surface coupling agent | 0~5 |

This formula encompasses combinations of a plurality of functional master batches; flame retardant master batches, antistatic master batches and color master batches for biodegradation may be prepared according to actual needs, or, multifunctional mixed master batches may also be prepared, e.g. flame retardant and antistatic master batch for biodegradation, etc.

In the present invention, on the basis of the features of the monomers or prepolymers, such as good mobility, reaction activity and in-situ modification, additives are well dispersed in these monomers or prepolymers to prepare master batches with different functions. The monomers and additives are strong in interface interaction and uniform in dispersion, furthermore, a master batch with higher addition amount can be prepared; further, a preparation method of the novel biodegradable master batch is set forth by full utilization of the features of biodegradable monomer polymerization and in-situ chemical modification; this method, which is different from traditional methods for preparation of the master batch by direct blending of high-viscosity polymers and additives, is featured by starting with the biodegradable monomer or prepolymer, achieving better dispersion of the additives through in-situ polymerization at the presence of the reaction activator, and finally preparing a biodegradable active master batch having strong interface interaction and uniform dispersion; the master batch having active end groups is capable of further improving the compatibility between matrix and additives in a finished composite material so as to further prepare a biodegradable composite material that has better performances than common master batches.

In conclusion, this technology overcomes the following defects in conventional master batch preparation methods: 1) the high-viscosity polymer carrier is hardly mixed with the additives, and the processing is difficult; 2) there is a poor compatibility between matrix and additives; and 3) to improve the compatibility, the master batch requires addition of the activator.

### Biodegradable Monomer and Prepolymer Thereof

The biodegradable monomer in the present invention is a monomer/prepolymer used in preparation of biodegradable polymer, including: monomers like hydroxy acid, diacid, diol, triol, tetrol, ester, etc.; specifically: lactic acid, succinic acid, adipic acid, terephthalic acid, butanediol, glycerol, pentaerythritol, lactide, glycolide, caprolactone, etc.; the biodegradable monomer may be one of the monomers, or some of the monomers in combination. The biodegradable monomer/prepolymer may be a prepolymer formed by these monomers. The content of the biodegradable monomer/prepolymer may be 10-80% (or in weight parts), and the content of the biodegradable monomer/prepolymer in preparation of a high-concentration master batch is 10-80%.

Specifically, the biodegradable monomer/prepolymer may be one of the monomers, or some of the monomers in combination. The biodegradable monomer/prepolymer may also be a prepolymer formed by these monomers, etc.

In one embodiment of the present invention, the biodegradable monomer is hydroxy acid, diacid, diol, triol, tetrol, ester or combinations thereof used in preparation of biodegradable polymer; the prepolymer is a prepolymer derived from the hydroxy acid, diacid, diol, triol, tetrol, ester or combinations thereof and having a degree of polymerization of 50-5000.

In one embodiment of the present invention, the biodegradable monomer is lactic acid, succinic acid, adipic acid, terephthalic acid, butanediol, glycerol, pentaerythritol, lactide, glycolide, caprolactone or combinations thereof;

The prepolymer is a prepolymer derived from the lactic acid, succinic acid, adipic acid, terephthalic acid, butanediol, glycerol, pentaerythritol, lactide, glycolide, caprolactone or combinations thereof and having a degree of polymerization of 50-5000.

### Catalyst

Specifically, the catalyst is selected from those that are required in polymerization of these monomers. The catalysts that can be used in the present invention mainly are Group I-V metals in the periodic table of elements, metal salt, hydroxide, chloride and oxide, etc. The preferred metal elements are: zinc, tin, aluminum, magnesium, antimony, titanium, zirconium, etc. The alternative specific catalysts are: zinc oxide, zinc lactate, zinc stearate, stannous chloride, stannous octoate, tetrabutyl tin, aluminum oxide, titanium butoxide, butyl titanate, isopropyl titanate, titanium tetraisopropoxide, antimony oxide, ferric oxide, ferric acetylacetonate, etc.

In one embodiment of the present invention, the catalyst includes Group I-V metals in the periodic table of elements, metal salt, hydroxide, chloride, oxide or combinations thereof;

Preferably, the catalyst is the metal below: zinc, tin, aluminum, magnesium, antimony, titanium, zirconium or combinations thereof; or the salt, hydroxide, chloride, oxide of the metal;

More preferably, the catalyst is: zinc oxide, zinc lactate, zinc stearate, stannous chloride, stannous octoate, tetrabutyl tin, aluminum oxide, titanium butoxide, butyl titanate, isopropyl titanate, titanium tetraisopropoxide, antimony oxide, ferric oxide, ferric acetylacetonate or combinations thereof.

### Reaction Activator

The reaction activators used in the present invention are substances that are capable of reacting with carboxyl and hydroxyl, in order to improve the compatibility between filler and monomer or prepolymer and further optimize dispersion. They may be epoxy group activators, anhydride group activators, isocyanate group activators, oxazoline group activators or unsaturated double bond-containing activators, etc. The epoxy group activators include: epoxy group-containing acrylate activators, glycidyl methacrylate activators and epoxidized soybean oil epoxy group activators, etc. Preferably, the epoxy group activator is an epoxy group activator of the oligomer or prepolymer containing at least 3 epoxy groups/chain segments and having a molecular weight lower than 5000. A specific activator suitable for the system of the present invention is Joncryl™ series products from BASF Corporation, U.S.A. Other reaction activators may be carbodiimides, anhydrides or isocyanate substances, including: dicyclohexyl carbodiimide, diisopropyl carbodiimide, bis(2,6-diisopropylphenyl)carbodiimide, 1-ethyl-(3-dimethylaminopropyl)-carbodiimide hydrochloride, Stabaxol-P, Stabaxol-P200, Stabaxol-100 and Stabaxol-I maleic from Rhein Chemie, Germany, anhydrides, glycidyl methacrylate, hexamethylene-1,6-diisocyanate, 1,6-cyclohexyl diisocyanate, 4,4′-methylene bis(cyclohexyl isocyanate), lysine methyl ester diisocyanate and butane diisocyanate, etc.

In one embodiment of the present invention, the reaction activator is epoxy group activator, anhydride group activator, isocyanate group activator, oxazoline group activator or unsaturated double bond-containing reaction activator capable of reacting with carboxyl and hydroxyl.

In one embodiment of the present invention, the epoxy group activator includes: epoxy group-containing acrylate epoxy group activator, glycidyl methacrylate epoxy group activator and epoxidized soybean oil epoxy group activator;

Preferably, the epoxy group activator is an epoxy group activator of the oligomer or prepolymer containing at least 3 epoxy groups/chain segments and having a molecular weight lower than 5000.

A specific activator suitable for the system of the present invention is Joncryl™ series products from BASF Corporation, U.S.A. Other reaction activators may be carbodiimides, anhydrides or isocyanate substances, including: dicyclohexyl carbodiimide, diisopropyl carbodiimide, bis(2,6-diisopropylphenyl)carbodiimide, 1-ethyl-(3-dimethylaminopropyl)-carbodiimide hydrochloride, Stabaxol-P, Stabaxol-P200, Stabaxol-100 and Stabaxol-I from Rhein Chemie, Germany, maleic anhydride, glycidyl methacrylate, 1,6-cyclohexyl diisocyanate, 4,4′-methylene bis(cyclohexyl isocyanate), lysine methyl ester diisocyanate, butane diisocyanate, etc.

### Thermal Stabilizer

The thermal stabilizer used in the present invention aims at ensuring that the biodegradable master batch keeps stable and avoids degradation during melt mixing or reprocessing, and this is mainly for reduction of thermal degradation and hydrolysis. The amount of the thermal stabilizer used is adjusted according to specific preparation routes and process conditions like processing temperature, and the typical amount is 0.1-5%.

In one embodiment of the present invention, the thermal stabilizer is phosphate complex antioxidant, hindered phenol complex antioxidant and complex antioxidant of the both, including: triaryl phosphite, trialkyl phosphite, trialkyl aryl phosphate ester, alkyl aryl phosphate ester, trithio alkyl ester, bis-phosphite and polymeric phosphite, pentaerythritol ester, and mixtures thereof.

The primary commercial products of the thermal stabilizer are: antioxidant 1010, antioxidant 168, TNPP, Irgafos168, Ultranox626, Cyanox2777, Irganox B, Irganox LC, IrganoxLM, IrganoxHP, IrganoxXP, Ultranox815A, Ultranox 817A, Ultranox 875A, Naugard900, CyanoxXS4, etc.

Additives like flame retardant, filler, antistatic agent, pigment and foaming agent

Additives like flame retardant, filler, antistatic agent, pigment and foaming agent are main parts for realizing functionalization of the master batch, and they are fully dispersed in the biodegradable monomer or prepolymer and contained in the resin matrix when a polymer long chain is formed by monomer reaction. These additives mainly are inorganic powders that have strong interface interaction and good infiltration effect with the biodegradable monomer or prepolymer, the particle size of these powders is preferably not more than tens of microns, and smaller particle size brings better effect of the prepared master batch.

In one embodiment of the present invention, the flame retardant is additive flame retardant, including zinc borate, zinc fluoroborate, aluminum hydroxide, magnesium hydroxide, magnesium stearate, antimony trioxide, red phosphorus, phosphate ester, ammonium polyphosphate, ammonium polyphosphate, phosphor-nitrogen flame retardant, silicon compound, copper nitrate, silver nitrate, expandable graphite, montmorillonite, layered double hydroxide, melamine, dicyandiamide, guanidine salt and derivatives thereof, tin molybdenum compound, silicon dioxide;

the filler is silicate filler, silica filler, oxide filer and metal powder filler, including: calcium carbonate, calcium sulfate, montmorillonite, talcum powder, starch, chitosan, chitin, glass bead, asbestos, mica, silica, wood powder, shell powder, attapulgite, clay, carbon black, pottery clay, cellulose, or metal powder;

the antistatic agent is cationic quaternary ammonium salt, amine salt, alkyl imidazoline, anionic phosphate, sulfonate, nonionic polyol, polyol ester, fatty acid ester, ethylene oxide adduct of alkyl amine, amphoteric quaternary ammonium salt, alanine salt, carbon black and metal powder;

the pigment is titanium dioxide, carbon black, lithopone, chrome yellow, iron blue, iron oxide yellow, silver powder, brass powder, pigment scarlet, aza yellow, phthalocyanine blue, quinacridone, cinnabar, red clay, realgar, malachite green, calcium carbonate, wollastonite, barite powder, talcum powder, mica powder, or kaolin;

The foaming agent is mainly an additive-type chemical and physical foaming agent: mainly including: azo compounds, N-nitroso compounds, sulfonyl hydrazide compounds, carbamido compounds, carbonates, nitrites, and physical foaming agents, etc.

The foaming agent may be specifically selected from: chemical foaming agents, including: amine azodicarboxylate, diisopropyl azodicarboxylate, azodiisobutyronitrile, ammonium azodicarbonate, barium azodicarboxylate, N, N′-dinitroso pentamethylene tetramine, N, N′-dinitroso terephthalamide, sodium nitrite-ammonium chloride mixture, urea, p-toluene sulfonyl hydrazide, phenyl sulfonyl hydrazide, p-diphenyl sulfonyl hydrazide acid, sodium bicarbonate, ammonium bicarbonate, polycarbonate/carbonate mixtures.

The common physical foaming agents are alkane and fluorocarbon compounds with a low boiling point, including n-pentane, n-hexane, n-heptane, petroleum ether, trichlorofluoromethane, dichlorodifluoromethane, dichlorotetrafluoroethane, etc.

The surface coupling agent is silane coupling agent, titanate coupling agent, aluminate coupling agent, bimetal coupling agent, phosphate coupling agent, borate coupling agent, chromium complex, zirconium coupling agent, rare earth coupling agent, and mixed coupling agents thereof.

The surface coupling agent used in the present invention mainly includes silane surface coupling agents, aluminate coupling agents and titanate coupling agents. Owing to addition of the additives to the monomer or prepolymer having a low molecular weight, use of a small amount of the surface coupling agent could result in excellent effect based upon the feature that the additives generate the master batch during in-situ polymerization of the biodegradable monomer, and in some cases, the surface coupling agent may not be used. This is incomparable for traditional methods.

The surface coupling agent may be selected from the group consisting of: γ-neno propyl trimethoxyzasilane, vinyl trichlorosilane, vinyl triethoxysilane, vinyl trimethoxysilane, vinyl tris(β-methoxyethoxy)silane, γ-(methacryloyloxy)propyl trimethoxysilane, β-(3,4-epoxy cyclohexyl)ethyl trimethoxysilane, γ-(2,3-epoxy propoxy)propyl trimethoxysilane, titanate coupling agent: isopropyl tri(isostearoyl)titanate, isopropyl tri(dioctyl pyrophosphate)titanate, bis(dioctyl pyrophosphoryl)oxygen-containing titanium acetate, tetraisopropyl bis(dilauryl phosphite)titanate, isopropyl tri(dioctyl pyrophosphoryl)titanate, bis(dioctyl pyrophosphoryl)ethylene titanate, pyrophosphoric acid monoalkoxy titanate, plant acid monoalkoxy titanate, phosphoric acid monoalkoxy titanate, isopropyl di(methacryloyl)isostearoyl titanate, isopropyl tri(dioctyl phosphoryl)titanate, isopropyl tri(dodecylbenzene sulfonyl)titanate, isopropyl tri(n-ethylamino-ethylamino)titanate, etc.

### Preparation Method

According to the present invention, the biodegradable master batch is prepared by a novel preparation method, and has stronger interface interaction and larger specific surface area with the additives by means of excellent mobility of the biodegradable monomer or prepolymer. The performances are improved instead of being degraded because there is a strong phase interface interaction between additives and matrix and the biodegradable monomer or prepolymer is not affected. This ensures that the biodegradable master batch prepared in the present invention is not only imparted with our desired functions and larger addition amount, but also avoids degradation in own physical performances. In this biodegradable master batch, the additives may be filler, flame retardant, pigment and foaming agent, etc., one or more of them may be selected, the addition mass fraction of each additive is 0-80%, and the temperature for blending extrusion is 50-220 □.

Specifically, the biodegradable master batch prepared in the present invention may be prepared according to two process routes.

The first process route lies in preparation of the biodegradable master batch by a reactive extrusion method. In this route, biodegradable monomer, auxiliaries, additives and the like are firstly dry-mixed or melt-mixed, and then, polymerization of the biodegradable monomer and formation of the biodegradable master batch are carried out simultaneously in an extrusion device. Such a method is capable of continuous production, has short period and relatively rigorous processing conditions, and contributes to implementation of industrial production.

The second process route lies in intermittent preparation of the biodegradable master batch by a two-step method. In this method, the prepolymer having a particular molecular weight is prepared by polymerization in a reaction kettle at first, and then, the additives are added in a side feeding way to prepare the biodegradable master batch by extrusion, or the biodegradable prepolymer and the additives are mixed at first and then the biodegradable master batch is prepared. Such a process route has lower production efficiency and longer period than the first process route, but it requires no special reactive extrusion device, and is not rigorous in processing requirements and relatively moderate in process conditions, so this process route is easy to implement.

The biodegradable master batch of the present invention is applicable to manufacturing of films, sheets, injection molding, profiles and containers, etc.

In one embodiment of the present invention, a preparation method of the biodegradable master batch of the present invention includes the steps:

(a) Providing the components of the present invention;

(b) Carrying out in-situ polymerization of the components to obtain the master batch.

In one embodiment of the present invention, in the step (b), in-situ polymerization and preparation of the master batch are carried out synchronously in an extrusion device, or

In the step (b), the components are prepolymerized at first and then extruded to obtain the master batch.

Specifically, prepolymerization is carried out in a reaction kettle.

### Advantages

The present invention relates to a preparation method of a novel biodegradable master batch and relevant processes. The present invention has the characteristic that, a variety of functional additives or the mixtures thereof are added at the stage of biodegradable monomer or prepolymer to accomplish full mixing, and the low-viscosity monomer or prepolymer guarantees addition of more additives. Afterwards, polymerization of the biodegradable monomer or prepolymer is initiated to guarantee that the polymerization-resulting polymer matrix and the additives in the prepared biodegradable master batch have better dispersion and excellent interface property. The reaction activator is added to react with the carrier, so as to generate active end groups; the reaction activator is capable of chemical/physical reaction with the additives to improve the compatibility between the carrier and the matrix of the finished composite material, dispersion of the additives is more uniform, and more additives are added. Thus, addition of the master batch to the prepared composite material could bring about more addition of the additives, improvement of the compatibility and better performances. Preparation of this master batch can be carried out in existing equipment such as reaction kettle or extruder. In preparation of the master batch, the problem of poor interface bonding force between plastic matrix and additives is typically solved by use of the surfactant, and use of this master batch tends to cause degradation of the mechanical performances, unsatisfactory dispersion and poor modification effect in a finished plastic product. The biodegradable-dedicated master batch of the present invention, which is prepared by an in-situ polymerization process, is capable of solving this problem well, in addition, this master batch is not only good in dispersion and easy for processing, but also has large addition amount and better performances.

Other aspects of the present invention will become readily apparent to those skilled in this art owing to the disclosure herein.

The present invention will be further illustrated below in conjunction with specific examples. It shall be understood that, these examples are for illustrative purposes only, rather than limitations to the scope of the present invention. In the examples below, measurements in the experimental methods with specific conditions unspecified are typically performed in accordance with national standards. In case of absence of the respective national standards, measurements are performed in accordance with general international standards and general conditions or with conditions suggested by manufacturers. Unless otherwise stated, all the parts are by weight and all the percents are by weight.

Unless otherwise defined or stated, all professional and scientific terms used herein are identical to the meanings with which those skilled in this art are familiar. In addition, any methods or materials similar or equivalent to the contents documented could all be applied to the method of the present invention.

Reference could be made to the examples below in detailed description of the present invention. These examples are for a better understanding of the inventive contents only, rather than limitations to the technical scope covered by the present invention.

### [Example 1] Preparation of a biodegradable master batch with high content of calcium sulfate

The first process route of the present invention is adopted: under the protection of dry nitrogen, 8 kg of Iactide is added to a high-speed mixer at first and then stirred, 1 minute later, 100 g of stannous octoate, 200 g of ADR4368C and 150 g of each of TNPP/Irgafos 168 are orderly added to the high-speed mixer and mixed for 3 minutes, and finally, 11.88 kg of calcium sulfate is added and mixed for 3 minutes; different mixing speeds are adjusted to achieve full and uniform mixing. The properly-mixed materials are measured by a feed hopper and added to an extruder for melt extrusion and hot-cutting granulation to obtain the biodegradable master batch with 60% of calcium sulfate. Polymerization of the master batch and the monomer is carried out in one step, in this way, the cost is saved, and furthermore, direct preparation of the master batch from the lactide monomer results in better mobility and easier processing. The typical extruder temperature is 80-220° C., and the rotating speed of the screw is 20-50 rpm.

### [Example 2] Preparation of a Biodegradable Master Batch with High Content of Carbon Black

The first process route of the present invention is adopted: under the protection of dry nitrogen, free water is removed from 88% lactic acid in a reaction kettle to obtain 9.0 kg of pure L-lactic acid at first, then 120 g of pentaerythritol, 150 g of stannous octoate and 400 g of antioxidant 1010/168 are orderly added to the reaction kettle for fully mixing, afterwards, 11.0 kg of carbon black is added to the reaction kettle via a special pipeline, the temperature is raised up to 190° C., and reaction is continuously maintained for 10 hours under a certain degree of vacuum. The materials that undergo the whole reaction are subjected to melt extrusion and hot-cutting granulation in an extruder connected with the reaction kettle, to obtain the antistatic biodegradable master batch with 55% of carbon black. The typical extruder temperature is 80-220° C., and the rotating speed of the screw is 50-100 rpm.

### [Example 3] Preparation of a Biodegradable Master Batch with High Content of Nano Calcium Carbonate

The second process route of the present invention is adopted: at first, a biodegradable PBSA prepolymer is prepared by direct condensation polymerization. The specific procedure is as follows: 8.2 kg of 1,4-butanediol (99%), 8.9 kg of succinic acid and 2.2 kg of adipic acid are added to a 50 L reactor with heating and stirring reactors, and mixed, and then, 97.0 g of tetrabutyl titanate (99%) is added as reaction catalyst. The mixing reaction temperature is set as 120 □, the temperature rises to 180 □ at a rate of 30 □/hour and is kept for 5 hours at every temperature point, and stirring is maintained at the same time. During temperature rise, a vacuum system is switched on to reduce the degree of vacuum to 50 mbar at a rate of 100 mbar/hour. Then, the temperature rises to 220 1 and is kept for 5 hours. After that, vacuum release is carried out, and the finished prepolymer is extruded by an extruder, cooled and granulated. The typical extrusion temperature is: 80-150 □, the rotating speed of the screw is 120 rpm. The active prepolymer product is pale yellow and has a reduced viscosity of 0.82 dl/g, a molecular weight of 51,000 Daltons and a melting point of 96 □.

Then, 13.50 kg of nano calcium carbonate is put in a high-speed mixer with the mixing speed being set as 300 rpm, and 203 g of plant acid monoalkoxy titanate coupling agent is slowly dripped into this calcium carbonate. The mixing speed is increased to 1200 rpm after dripping, those substances are mixed for 3 minutes, the mixture is transferred to a drying unit for drying reaction for half an hour at 1201 , and the resulting product is preserved for future use. At first, 6 kg of the prepared PBSA prepolymer is added to the high-speed mixer and stirred at a low speed, then 60 g of stannous octoate, 240 g of hexamethylene-1,6-diisocyanate (HMDI) and 150 g of each of TNPP/Irgafos 168 are orderly added to the high-speed mixer for mixing for 3 minutes, and finally, all the calcium carbonate that is properly processed is added and mixed for 3 minutes, and different mixing speeds are adjusted to achieve full and uniform mixing. The properly-mixed materials are measured by a feed hopper and added to an extruder for melt extrusion and hot-cutting granulation to obtain the biodegradable master batch with 67.5% of nano calcium carbonate. The typical extruder temperature is 60-180° C., and the rotating speed of the screw is 20-50 rpm.

### [Example 4] Preparation of a Mixed Biodegradable Master Batch with High Content of Magnesium Hydroxide and Titanium Dioxide

The second process route of the present invention is adopted: at first, a biodegradable PBS prepolymer is prepared by direct condensation polymerization. The specific procedure is as follows: 8.2 kg of 1,4-butanediol (99%) and 11.8 kg of succinic acid are added to a 50 L reactor with heating and stirring reactors, stirred and mixed, and then, 106.0 g of tetrabutyl titanate (99%) is added as reaction catalyst. The mixing reaction temperature is set as 120 □, the temperature rises to 180 □ at a rate of 30 □/hour and is kept for 5 hours at every temperature point, and stirring is maintained at the same time. During temperature rise, a vacuum system is switched on to reduce the degree of vacuum to 10 mbar at a rate of 100 mbar/hour. Then, the temperature rises to 220 □ and is kept for 5 hours. After that, vacuum release is carried out, the temperature of the reaction kettle is reduced to 150 □, 300 g of tin stearate, 800 g of hexamethylene-1,6-diisocyanate (HMDI) and 500 g of each of TNPP/Irgafos 168 are orderly and slowly added and then fully mixed, and the resulting mixture is preserved for future use.

Simultaneously, 8.0 kg of magnesium hydroxide and 5.0 kg of titanium dioxide are weighed and put in a high-speed mixer, and different mixing speeds are set to mix those substances for 5 minutes. The properly-mixed materials are added in a side feeding way to an extruder connected with the reaction kettle, and then subjected to melt coextrusion and hot-cutting granulation together with the properly-processed PBS prepolymer, so as to obtain the high-filling flame-retardant mixed biodegradable master batch. The PBS prepolymer product that is prepared using this process is pale yellow and has a reduced viscosity of 1.04 dl/g, a molecular weight of 63,000 Daltons and a melting point of 115 □. The typical extruder temperature is 80-200° C., and the rotating speed of the screw is 20-50 rpm.

Described above are the preferred examples of the present invention only, which are not intended to limit the scope of the substantial technical content of the present invention. The substantial technical content of the present invention is broadly defined in the scope of claims of this application, and any technical entities or methods achieved by others shall all be contemplated as being covered by the scope of claims in case that they are completely identical to those defined by the scope of claims of this application or regarded as an equivalent alteration.

All the documents mentioned in the present invention are cited in this application for reference, just as each of the documents is independently cited for reference. In addition, it shall be understood that, a variety of amendments or modifications could be made to the present invention by those skilled in this art who have already read the aforementioned content of the present invention, and likewise, these equivalent forms fall within the scope defined by the appended claims of this application.

1. A biodegradable master batch, characterized in that: the biodegradable master batch is prepared by in-situ polymerization of the components in the following formula in weight parts:
10-80 parts of biodegradable monomer or prepolymer;
0.01-5 parts of catalyst;
0.05-5 parts of reaction activator;
0.1-5 parts of thermal stabilizer;
0-80 parts of flame retardant;
0-80 parts of filler;
0-80 parts of antistatic agent;
0-80 parts of pigment;
0-80 parts of foaming agent; and
0-5 parts of surface coupling agent.

2. The biodegradable master batch according to claim 1, characterized in that,
the biodegradable monomer is hydroxy acid, diacid, diol, triol, tetrol, ester or combinations thereof used in preparation of biodegradable polymer; or
the prepolymer is a prepolymer derived from the hydroxy acid, diacid, diol, triol, tetrol, ester or combinations thereof and having a degree of polymerization of 50-5000.

3. The biodegradable master batch according to claim 2, characterized in that,
the biodegradable monomer is lactic acid, succinic acid, adipic acid, terephthalic acid, butanediol , glycerol, pentaerythritol, lactide, glycolide, caprolactone or combinations thereof;
the prepolymer is a prepolymer derived from the lactic acid, succinic acid, adipic acid, terephthalic acid, butanediol glycerol, pentaerythritol, lactide, glycolide, caprolactone or combinations thereof and having a degree of polymerization of 50-5000.

4. The biodegradable master batch according to claim 1, characterized in that, the catalyst includes Group I-V metals in the periodic table of elements, metal salt, hydroxide, chloride, oxide or combinations thereof;
preferably, the catalyst is the metal below: zinc, tin, aluminum, magnesium, antimony, titanium, zirconium or combinations thereof; or the salt, hydroxide, chloride, oxide of the metal;
more preferably, the catalyst is: zinc oxide, zinc lactate, zinc stearate, stannous chloride, stannous octoate, tetrabutyl tin, aluminum oxide, titanium butoxide, butyl titanate, isopropyl titanate, titanium tetraisopropoxide, antimony oxide, ferric oxide, ferric acetylacetonate or combinations thereof.

5. The biodegradable master batch according to claim 1, characterized in that, the reaction activator is epoxy group activator, anhydride group activator, isocyanate group activator, oxazoline group activator or unsaturated double bond-containing reaction activator capable of reacting with carboxyl and hydroxyl.

6. The biodegradable master batch according to claim 5, characterized in that,
the epoxy group activator includes: epoxy group-containing acrylate epoxy group activator, glycidyl methacrylate epoxy group activator and epoxidized soybean oil epoxy group activator;
preferably, the epoxy group activator is an epoxy group activator of the oligomer or prepolymer containing at least 3 epoxy groups/chain segments and having a molecular weight lower than 5000.

7. The biodegradable master batch according to claim 1, characterized in that, the thermal stabilizer is phosphate complex antioxidant, hindered phenol complex antioxidant and complex antioxidant of the both, including: triaryl phosphite, trialkyl phosphite, trialkyl aryl phosphate ester, alkyl aryl phosphate ester, trithio alkyl ester, bis-phosphite and polymeric phosphite, pentaerythritol ester, and mixtures thereof.

8. The biodegradable master batch according to claim 1, characterized in that,
the flame retardant is additive flame retardant, including zinc borate, zinc fluoroborate, aluminum hydroxide, magnesium hydroxide, magnesium stearate, antimony trioxide, red phosphorus, phosphate ester, ammonium polyphosphate, ammonium polyphosphate, phosphor-nitrogen flame retardant, silicon compound, copper nitrate, silver nitrate, expandable graphite, montmorillonite, layered double hydroxide, melamine, dicyandiamide, guanidine salt and derivatives thereof, tin molybdenum compound, silicon dioxide; and/or
the filler is silicate filler, silica filler, oxide filer and metal powder filler, including: calcium carbonate, calcium sulfate, montmorillonite, talcum powder, starch, chitosan, chitin, glass bead, asbestos, mica, silica, wood powder, shell powder, attapulgite, clay, carbon black, pottery clay, cellulose, or metal powder; and/or
the antistatic agent is cationic quaternary ammonium salt, amine salt, alkyl imidazoline, anionic phosphate, sulfonate, nonionic polyol, polyol ester, fatty acid ester, ethylene oxide adduct of alkyl amine, amphoteric quaternary ammonium salt, alanine salt, carbon black and metal powder; and/or
the pigment is titanium dioxide, carbon black, lithopone, chrome yellow, iron blue, iron oxide yellow, silver powder, brass powder, pigment scarlet, aza yellow, phthalocyanine blue, quinacridone, cinnabar, red clay, realgar, malachite green, calcium carbonate, wollastonite, barite powder, talcum powder, mica powder, or kaolin; and/or
the foaming agent is azo compound, N-nitroso compound, sulfonyl hydrazide compound, carbamido compound, carbonate, nitrite, or physical foaming agent,
the surface coupling agent is silane coupling agent, titanate coupling agent, aluminate coupling agent, bimetal coupling agent, phosphate coupling agent, borate coupling agent, chromium complex, zirconium coupling agent, rare earth coupling agent, and mixed coupling agents thereof.

9. A preparation method of the biodegradable master batch according to claim 1, characterized in that, the method includes the steps:
(a) providing the components according to claim 1;
(b) carrying out in-situ polymerization of the components to obtain the master batch.

10. The method according to claim 1, characterized in that,
in the step (b), in-situ polymerization and preparation of the master batch are carried out synchronously in an extrusion device, or
in the step (b), the components are prepolymerized at first and then extruded to obtain the master batch.
